(19) United States
(12) Patent Application Publication
(10) Pub. No.: US 2004/0083744 A1
(43) Pub. Date: May 6, 2004

(54) LOW-CHARGE LEAK DETECTION STRATEGY FOR DUAL AUTOMATIC TEMPERATURE CONTROL SYSTEM

(75) Inventor: Shane A. Harte, Farmington Hills, MI (US)

Correspondence Address: VISTEON 29074, BRINKS HOFER GILSON & LIONE, P.O. BOX 10395, CHICAGO, IL, 60611, US

(73) Assignee: Visteon Global Technologies, Inc.

(21) Appl. No.: 10/287,176

(22) Filed: Nov. 4, 2002

(51) Int. Cl. G01K 13/00; F25B 45/00

(52) U.S. Cl. 62/130; 62/292

(57) ABSTRACT

A method and system for detecting a low-charge condition in a dual-output vehicle air conditioning system. A program reads a set of evaporator, driver-side, and passenger-side temperatures for the purpose of adjusting a temperature in a vehicle passenger compartment. A diagnostic program then analyzes these same readings to determine whether a temperature differential condition exists. Assuming a temperature differential condition exists, the program records a set of the temperature sensor readings and a time period for these temperature readings. The diagnostic program compares this set of information with a set of stored data to determine whether a low-charge condition exists.—

### FIELD OF INVENTION

This invention relates to automobile air conditioning systems. More particularly, the invention relates to a method and system for detecting low refrigerant charge in a dual-output vehicle air conditioning system.

### BACKGROUND OF THE INVENTION

A dual-output vehicle air conditioning system allows a driver or passenger to individualize a temperature in a driver-side or passenger-side position of a passenger compartment in a vehicle. The dual-output vehicle air conditioning system accomplishes this by cooling air over an evaporator and then reheating the same air flowing through a heater core having dual flowpaths over a dual core. This individualized reheat allows the system to discharge warmer air or cooler air via separate flowpaths, into either the driver-side or the passenger-side position of the passenger compartment according to a desired temperature input at the driver-side or passenger-side position. The individual temperature inputs are checked by temperature sensors that are placed in each flowpath duct adjacent the core.

Typically, a dual-output vehicle air conditioning system consists of a blower, an evaporator, a dual heater core, two heater core solenoid valves, and three temperature sensors. Normally, the first temperature sensor is located close to the evaporator outlet, the second temperature sensor is located close to the dual heater core outlet on the driver side, and the third temperature sensor is located close to the dual heater core outlet on the passenger side.

The vehicle air conditioning system operates correctly when the evaporator maintains a constant temperature. However, varying temperatures across the evaporator is normally indicative of low-charge condition. During a low-charge condition, a portion of the evaporator becomes starved of liquid refrigerant charge. This lack of refrigerant leaves a portion of the evaporator incapable of cooling and causes an inconsistent evaporator temperature.

It is therefore desirable to have a system that reliably detects a low-charge condition without adding additional hardware to a vehicle that implements a dual-output vehicle air conditioning system.

### BRIEF SUMMARY OF THE INVENTION

Accordingly, it is an object of the present invention to provide a method and system detecting a low-charge condition without adding additional hardware to a dual-output vehicle air conditioning system.

In one aspect of the present invention, a program first reads a set of evaporator, driver-side, and passenger-side temperatures for the purpose of adjusting a temperature in the vehicle passenger compartment. A diagnostic program then analyzes these same readings to determine whether a temperature differential condition exists. Assuming a temperature differential condition exists, the program records a set of the temperature sensor readings and a time period for these temperature readings. The program then compares this set of information with a set of stored data to determine whether a low-charge condition exists.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and descriptions are to be regarded as illustrations in nature and not as restrictive.

### BRIEF DESCRIPTION OF SEVERAL VIEWS OF THE DRAWINGS

FIG. 1 is a schematic diagram of a dual-output vehicle air conditioning system using telematics hardware in accordance with the present invention; and

FIG. 2 is a flowchart relating to low-charge detection in a dual-output vehicle air conditioning system in accordance with the present invention.

### DETAILED DESCRIPTION OF THE PREFERRED EMBODIMENTS

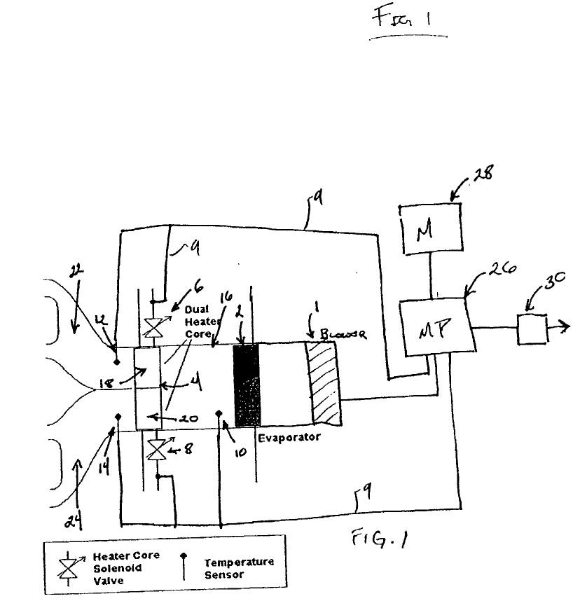

FIG. 1 is a schematic of a typical dual-output air conditioning system using telematics hardware that is used to implement the present invention. A dual-output air conditioning system consists essentially of a blower 1, an evaporator 2, a dual heater core 4, a driver-side heater core solenoid valve 6, a passenger-side heater core solenoid valve 8, an evaporator temperature sensor 10, a driver-side temperature sensor 12, and a passenger-side temperature sensor 14.

Initially, a blower 1 directs an air flow into an evaporator 2 where it is cooled using a refrigerant. After being cooled, the air flows out of the evaporator 2 and into a duct 16 leading to the dual heater core 4. The evaporator temperature sensor 10 is preferably located close to the evaporator outlet in this duct 16. This sensor measures temperature of the flow stream leaving the evaporator 2. The temperature sensor is typically a thermistor but any instrumentation can be used that can measure temperature.

After flowing through the duct 16 leading from the evaporator 2, the air flows into the dual heater core 4, which is preferably partitioned into at least two parts. A portion of the air flowing from the evaporator 2 flows into a driver-side inlet for the dual heater core 18. The remaining air flowing from the evaporator 2 preferably flows into a passenger-side inlet for the dual heater core 20.

Within the dual heater core 4, air is reheated to a temperature depending on the position of the driver-side heater core solenoid valve 6 and the position of the passenger-side heater core solenoid valve 8. The driver-side heater core solenoid valve 6 controls engine coolant flow within the driver-side portion of the dual heater core 4, and the passenger-side heater core solenoid valve 8 controls the engine coolant flow within the passenger-side portion of the dual heater core 4. The amount of coolant flow for either the driver side or passenger side of the dual heater core 4 is calculated based on the difference between a calculated ideal temperature value, and a real temperature value as measured by the driver-side temperature sensor 12 and passenger-side temperature sensor 14 located close to the outlets of the dual heater core 4.

After it is heated within the dual heater core 4, the air flows into ducts leading to the passenger compartment of the vehicle. The air cooled within the driver-side portion of the dual heater core 18 flows into a duct 22 leading to the driver-side portion of the passenger compartment. The driver-side temperature sensor 12 is preferably located in this duct 22. This sensor measures the temperature of the flow stream toward the driver-side portion of the vehicle passenger compartment and the dual-output vehicle air conditioning system uses this temperature reading to control the driver-side heater core solenoid valve 6.

The air that is heated within the passenger-side portion of the dual heater core 20 flows into a duct 24 leading to the passenger-side portion of the passenger compartment. The passenger-side temperature sensor 14 is preferably located in this duct 24. This sensor measures the temperature of the flow stream towards the passenger-side portion of the vehicle passenger compartment and the dual-output vehicle air conditioning system uses this temperature reading to control the passenger-side heater core solenoid valve 8.

To implement the present invention, the blower 1, evaporator temperature sensor 10, driver-side temperature sensor 12, passenger-side temperature senor 14, driver-side heater core solenoid valve 6, and passenger-side heater core solenoid valve 8 are electrically connected to or otherwise in connection with at least one microprocessor 26 via connections 9. Any type of microprocessor can be used with the functionality to run programs, communicate with an interface, and read and write data to a memory device. The particular programs stored within the microprocessor 26 are discussed below

To utilize the functionality of the microprocessor 26, the microprocessor 26 is in communication with a memory device 28 and an interface 30. Any type of memory can be used with that ability to write and store a set of data. The particular sets of data stored within the memory device 28 are discussed below. The interface 30 can be any device can be used with the ability to send sets of data to a new location.

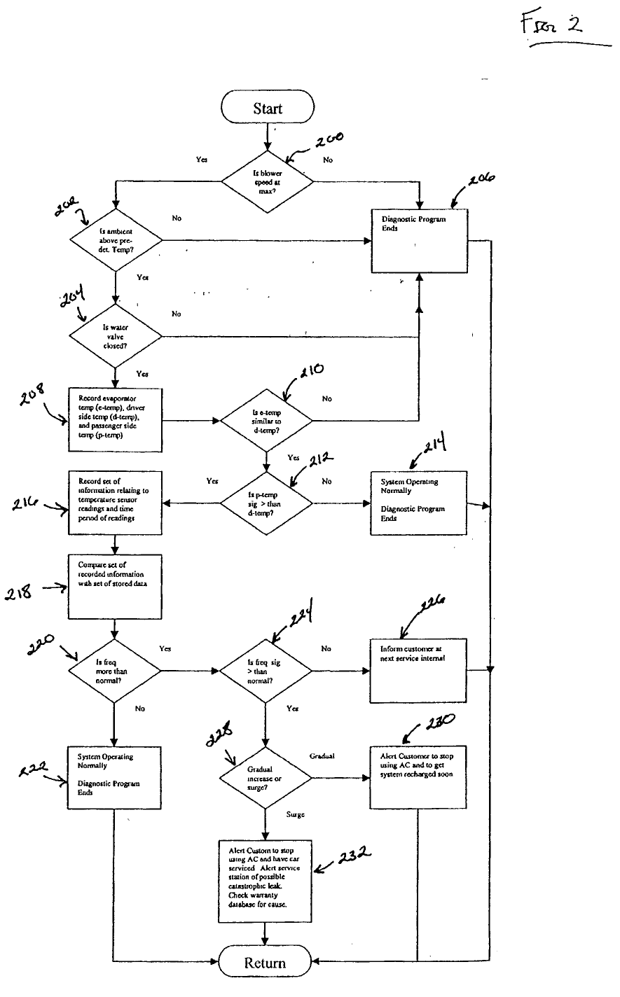

FIG. 2 is a flowchart relating to low-charge detection in a dual-output vehicle air conditioning system. In one embodiment of the present invention, at least one microprocessor 26 within the vehicle runs a diagnostic program to implement this method. The diagnostic program begins by determining whether the blower 1 within the system is set to maximum speed 200. A certain known blower speed is necessary to accurately measure temperature changes in the flow streams leaving the evaporator and heater core. For this reason, if the blower is not set at maximum speed, the diagnostic program ends 206.

If the blower 1 is indeed set at maximum speed, the diagnostic program next determines whether the ambient temperature is above a pre-determined temperature 202. The pre-determined temperature is the lowest temperature that can sustain a sufficient temperature difference between the driver-side temperature sensor and the passenger-side temperature sensor to establish a temperature differential condition. If the ambient temperature is not above the pre-determined temperature, the diagnostic program ends 206.

Assuming the ambient temperature is above the pre-determined temperature the program proceeds to determine whether the water valves are closed 204. To establish a reliable low-charge condition, the water valves must be closed. Otherwise, the water valve position could cause a temperature differential under normal operation, as opposed to a lack of refrigerant charge. For this reason, if the water valves are open, the diagnostic program ends 206.

These aforementioned conditions are normal occurrences for the dual-output air vehicle air conditioning system on a warm day during initial vehicle cool down. These conditions also occur with the point at which low-charge is first experienced.

Assuming the water valves in the system are closed, the program proceeds to read the evaporator, driver-side, and passenger-side temperatures 208 via the sensors 10, 12, and 14, respectively. These temperature readings are the same readings the dual-output vehicle air conditioning system uses to adjust the heater core solenoid valves, 6 and 8, when a user desires to adjust the temperature of the flow stream entering the passenger compartment of the vehicle.

The diagnostic program proceeds by comparing the evaporator temperature sensor reading 10 with the driver-side temperature sensor reading 12 to determine whether the temperatures are similar 210. For a potential temperature differential condition to exist, the evaporator and driver-side temperatures, as read by temperature sensors 10 and 12, need to be similar, preferably within 5° C. Otherwise, due to temperature changes within the system that are not related to refrigerant level, comparisons of temperature readings later in the diagnostic program could result in an inaccurate detection of low-charge condition. For this reason, if the evaporator temperature and driver-side temperature are not similar, or within a pre-determined range, the diagnostic program ends 206.

If the evaporator temperature and driver side temperature are similar, the diagnostic program next compares the driver-side temperate sensor reading with the passenger side temperature sensor reading 212. This comparison is done to determine whether a temperature differential condition exists. As noted above, a temperature differential condition exists when the passenger side temperature as read by sensor 14 is significantly warmer than the driver side temperature as ready by sensor 16. The difference in temperature is due to a portion of the evaporator 2 becoming starved of refrigerant. This lack of refrigerant leaves a portion of the evaporator incapable of cooling and results in inconsistent evaporator temperatures. For this reason, if the driver-side temperature is similar to the passenger-side temperature, the diagnostic program determines that the dual-output vehicle air conditioning system is operating normally and the diagnostic program ends 214.

If the passenger-side temperature is significantly warmer than the driver-side temperature, the diagnostic program records a set of information relating to the temperature readings 216 in the memory 26. Among other variables, the set of information that is recorded could include the ambient temperature, evaporator temperature, driver-side temperature, passenger-side temperature, date, time of day, ground positioning system coordinates, and the direction the vehicle is traveling.

After recording the set of information, the diagnostic program compares the set of recorded information with a set of stored data 218. The diagnostic program first determines whether the frequency of temperature differential conditions is above a pre-determined threshold 220. The purpose of the pre-determined threshold is to detect whether a potential low-charge condition exists with the system's refrigerant rather than when an anomaly has occurred. Therefore, if the frequency of temperature differential conditions is not above the pre-determined threshold, the dual-output vehicle air conditioning system is operating normally and the diagnostic program ends 222.

Assuming the frequency of temperature differential conditions is above the pre-determined threshold, the diagnostic program determines that a low-charge condition exists and proceeds to determine whether the frequency of temperature differential conditions is significantly above a pre-determined threshold 224. In determining the significance of frequency, the program uses the point at which the program should inform the vehicle operator to recharge the refrigerant in the vehicle. If the frequency of temperature differential conditions is not significantly above normal, the vehicle operator is informed at the next service interval of the low-charge condition 226.

If the frequency of temperature differential conditions is significantly above the pre-determined threshold, the program proceeds to examine whether the increase in temperature differential conditions has occurred gradually or in a surge 228. A gradual increase occurs when the number of temperature differential conditions occurs over a long period of time, such as a period of years. A surge occurs when the number of temperature differential conditions occurs over a relatively short period of time, such as a period of days or weeks. This step determines how the program suggests the vehicle operator to adjust their use of the vehicle.

If the increase in temperature differential conditions occurred gradually, the program preferably informs the vehicle operator to stop using the dual-output vehicle air conditioning system due to a low-charge condition and to recharge the system's refrigerant soon 230. The diagnostic program then ends.

Assuming the increase in temperature differential conditions occurred in a surge, the program preferably informs the vehicle operator to stop using the dual-output vehicle air conditioning system due to a low-charge level and to have the vehicle serviced immediately 232. If equipped with the means to communicate, the diagnostic program can then notify a service station of a possible catastrophic leak in the coolant system and checks a warranty database for the most likely source of the coolant leak.

In one embodiment of the present invention, the diagnostic program stores the stored data within the vehicle and the program compares the recorded data with the stored data within the vehicle itself. In this embodiment, any results of the comparisons indicating a low-charge condition would appear within the vehicle.

In another embodiment of the present invention, the diagnostic program transmits the recorded data to another location where a set of stored data is located. This can be an automobile maintenance facility, a local automobile dealer, or any other facility established to analyze the recorded data. In this embodiment, all comparisons are made at the new location. This provides real-time data on all automobiles and allows a program to notify a service station, in addition to the vehicle owner, when the program detects a low charge condition.

While preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

1. A method of detecting a low-charge condition for a dual-output vehicle air conditioning system comprising the steps of:
reading temperature sensors placed at at least two separate outputs of said system;
analyzing said temperature sensor readings to determine whether a temperature differential condition exists; and
comparing said temperature sensor readings with a set of stored values to determine whether a low-charge condition exists.

2. The method of claim 1, wherein the step of reading temperature sensors placed at at least two separate outputs of said system further comprises reading temperatures selected from the group consisting of ambient, evaporator, passenger-side, and driver-side temperatures.

3. The method of claim 1, wherein the step of analyzing said temperature sensor readings to determine whether a temperature differential condition exists further comprises comparing two or more temperature parameters to determine whether a temperature differential condition exists.

4. The method of claim 3, wherein the step of analyzing said temperature sensor readings to determine whether a temperature differential condition exists further comprises:
comparing an evaporator temperature to a driver-side temperature; and
comparing the driver-side temperature to a passenger-side temperature.

5. The method of claim 1, wherein the step of comparing said temperature sensor readings with a set of stored values to determine whether a low-charge condition exists further comprises:
storing a set of information relating to said temperature sensor readings at different time periods when a temperature differential condition exists; and
comparing said set of information with a set of stored values to determine whether a low-charge condition exists.

6. The method of claim 5, wherein the step of storing a set of information relating to said temperature sensor readings at different time periods further comprises storing a set of information selected from the group consisting of ambient temperature, evaporator temperature, passenger-side temperature, driver-side temperature, date, time of day, ground positioning system coordinates, and direction of travel.

7. The method of claim 5, wherein the step of comparing said set of information with a set of stored values to determine whether a low-charge condition exists further comprises comparing said set of information with a set of stored values for the same automobile.

8. The method of claim 5, wherein the step of comparing said set of information with a set of stored values to determine whether a low-charge condition exists further comprises comparing said set of information with a set of stored values for similar automobiles.

9. The method of claim 5, wherein the step of comparing said set of information with a set of stored values to determine whether a low-charge condition exists further comprises:
transferring said set of information to a new location from an automobile where said set of information was stored; and
comparing, at said new location, said set of information to a different set of temperature differential conditions values to determine whether a low-charge condition exists.

10. The method of claim 1, wherein the step of comparing the temperature sensor readings with a set of values to determine whether a low-charge condition exists further comprises:
comparing a recorded frequency of temperature differential conditions with a set of stored values to determine whether said recorded frequency is more than a pre-determined threshold;
determining whether said recorded frequency of temperature differential conditions is significantly more than said pre-determined threshold; and
determining whether an increase in said frequency of temperature differential conditions has occurred gradually or in a surge.

11. The method of claim 10, wherein the step of determining whether said recorded frequency of temperature differential conditions is significantly more than said pre-determined threshold further comprises informing a vehicle operator to adjust their use of said dual-output vehicle air conditioning system based on whether said recorded frequency of temperature differentials conditions is significantly more than said pre-determined threshold.

12. The method of claim 10, wherein the step of determining whether an increase in said frequency of temperature conditions has occurred gradually or in a surge further comprises:
informing a vehicle operator to adjust their use of said dual-output vehicle air conditioning system and to have said system serviced within a time interval;
informing a new location of the results of said method; and
checking a warranty database for a likely source of low-charge condition.

13. A method of detecting a low-charge condition for a dual-output vehicle air conditioning system using multiple temperature sensors, comprising the steps of:
reading two or more temperature sensors to adjust an automobile's passenger compartment temperature; and
analyzing said temperature readings to determine whether a low-charge condition exists.

14. The method of claim 13, wherein the step of analyzing said temperature readings to determine whether a low-charge condition exists further comprises:
comparing two or more of said temperature sensor readings to each other to determine whether a temperature differential condition exists;
storing a set of information relating to said temperature sensor readings at different time periods; and
comparing said set of information relating to said temperature sensor readings with a set of stored values to determine if a low-charge condition exists.

15. The method of claim 14, wherein the step of comparing two or more of said temperature sensor readings to each other to determine whether a temperature differential condition exists further comprises:
comparing an evaporator temperature sensor reading to a driver-side temperature sensor; and
comparing said driver-side temperature sensor reading to a passenger-side temperature sensor reading.

16. The method of claim 14, wherein the step of comparing said set of information relating to said temperature sensor readings with a set of stored values to determine if a low-charge condition exists further comprises:
comparing a recorded frequency of temperature differential conditions with a set of stored values to determine whether said recorded frequency is more than a pre-determined threshold;
determining whether said recorded frequency of temperature differential conditions is significantly more than said pre-determined threshold; and
determining whether an increase in said frequency of temperature differential conditions has occurred gradually or in a surge.

17. A system for detecting a low-charge condition in a dual-output vehicle air conditioning system comprising:
at least two temperature sensors for measuring two or more temperatures within said dual-output vehicle air conditioning system;
at least one microprocessor for analyzing said temperatures to determine whether a temperature differential condition exists; and
said at least one microprocessor for comparing said temperature readings with a set of stored values to determine whether a low charge condition exists.

18. The system of claim 17, further comprising at least one memory device for storing data, wherein said at least one microprocessor writes a set of information relating to said temperature readings to said memory device, and said at least one microprocessor reads a set of stored values and said set of information from said memory device.

19. The system of claim 18, further comprising an interface for transferring said set of information to a new location from an automobile where said set of information was stored, wherein said at least one microprocessor communicates with said interface.

20. A system for detecting a low-charge condition in a dual-output vehicle air conditioning system comprising:
a group of ducts, wherein said ducts extend between an evaporator and a dual heater core, and to a vehicle passenger compartment;
at least two temperature sensors placed within each of said ducts reading air flow temperatures out of the evaporator and the dual heater core;
at least one microprocessor electrically connected to said at least two temperature sensors comparing two or more said temperature readings to determine whether a temperature differential condition exists;
at least one memory device electrically connected to said at least one microprocessor storing a set of information relating to said temperature sensor readings when a temperature differential condition exists and to store a set of values relating to said temperature differential conditions; and
said at least one microprocessor comparing said set of information relating to said temperature sensor readings when a temperature differential condition exists with said set of stored values relating to temperature differential conditions to determine whether a low-charge condition exists.
